(19) United States
(12) Patent Application Publication
(10) Pub. No.: US 2005/0263965 A1
(43) Pub. Date: Dec. 1, 2005

(54) Planetary wheel with swivel capability

(76) Inventor: Ralph L. Barnett, Wilmette, IL (US)

Correspondence Address: Pauley Petersen & Erickson, Suite 365, 2800 West Higgins Road, Hoffman Estates, IL, 60195, US

(21) Appl. No.: 11/098,151

(22) Filed: Apr. 4, 2005

Related U.S. Application Data
(60) Provisional application No. 60/575,855, filed on Jun. 1, 2004.

(51) Int. Cl. B62B 5/02

(52) U.S. Cl. 280/5.26

(57) ABSTRACT

A planetary wheel system apparatus having swiveling outer satellite wheels mounted about the circumference of a central primary wheel provides superior obstacle climbing ability and maneuverability. The planetary wheel system helps eliminate abrupt jarring or stopping when wheeled conveyances, such as wheeled-chairs, carts, or the like, encounter obstacles to the forward motion of their wheels. Thus, the apparatus reduces the risk of injury and the breaking or jarring of any occupant or contents of the wheeled conveyance. The apparatus further provides increased access and mobility by enabling the traversal of obstacles which would otherwise block forward motion by permitting a wheeled conveyance to maneuver over obstacles more stably, smoothly, and with less effort in both frontal impacts and angular impacts with obstacles.

### CROSS REFERENCE TO RELATED APPLICATION

This application claims the benefit of U.S. Provisional Application No. 60/575,855, filed 1 Jun. 2004.

### BACKGROUND OF THE INVENTION

1. Field of the Invention

This invention relates to planetary wheel assemblies for wheeled conveyances. More particularly, the invention relates to a planetary wheel system having wheels which swivel.

2. Description of Related Art

Known planetary wheel systems have a single large primary wheel with equally spaced smaller satellite wheels mounted near the periphery of the primary wheel. These known wheel systems provide superior obstacle climbing capability compared to a single conventional wheel of equal diameter when encountering certain large obstructions. The planetary wheel system rolls on flat surfaces with two small wheels in contact with the ground.

Unfortunately, in the known planetary wheel systems the satellite wheels are fixed and do not swivel. Therefore existing planetary wheels cannot be easily steered and must drag sideways when rotated about a substantially vertical axis, inhibiting forward motion of the wheels and thereby limiting maneuverability, access, and mobility of a wheeled conveyance and, in some instances, the operator thereof.

### SUMMARY OF THE INVENTION

Accordingly, it is one object of this invention to provide an improved planetary wheel system for a wheeled conveyance.

It is another object of this invention to provide an improved planetary wheel system for a wheeled conveyance having satellite wheels which swivel and do not inhibit angular motion.

It is another object of this invention to provide an improved wheeled conveyance providing greater mobility and access for the operator thereof.

These and other objects of this invention are addressed by an improved planetary wheel system for a wheeled conveyance having a first or primary central wheel on which are mounted secondary or satellite outer wheels which swivel. The present invention helps eliminate abrupt jarring or stopping which happens when regular wheeled conveyances, such as wheeled-chairs, wheeled carts, or the like, either powered or un-powered, encounter obstacles to the forward motion of their wheels.

Thus, the present invention makes the wheeled conveyances safer for the rider and reduces the risk of injury and the breaking or jarring of any occupant or contents of the wheeled conveyances.

The present invention may also provide increased access and mobility by enabling the traversal of obstacles which would otherwise block forward motion by permitting a wheeled conveyance to stably maneuver over obstacles smoothly and with less effort in both frontal impacts and angular impacts with obstacles.

In exemplary embodiments of this invention, the planetary wheel system may include caster mounted or spherical satellite wheels.

### BRIEF DESCRIPTION OF THE DRAWINGS

These and other objects and features of the invention will be better understood from the following detailed description taken in conjunction with the appended claims and drawings.

FIG. 1 is a side view of a planetary wheel system on a wheeled chair, according to one exemplary preferred embodiment of this invention;

FIG. 2 is a detail view of the planetary wheel system of FIG. 1;

FIG. 3 is a side view of a second exemplary planetary wheel system according to another preferred embodiment of this invention;

FIG. 4 is a detail view of a spherical wheel assembly utilized in the embodiment of FIG. 3.

### DETAILED DESCRIPTION OF PREFERRED EMBODIMENTS

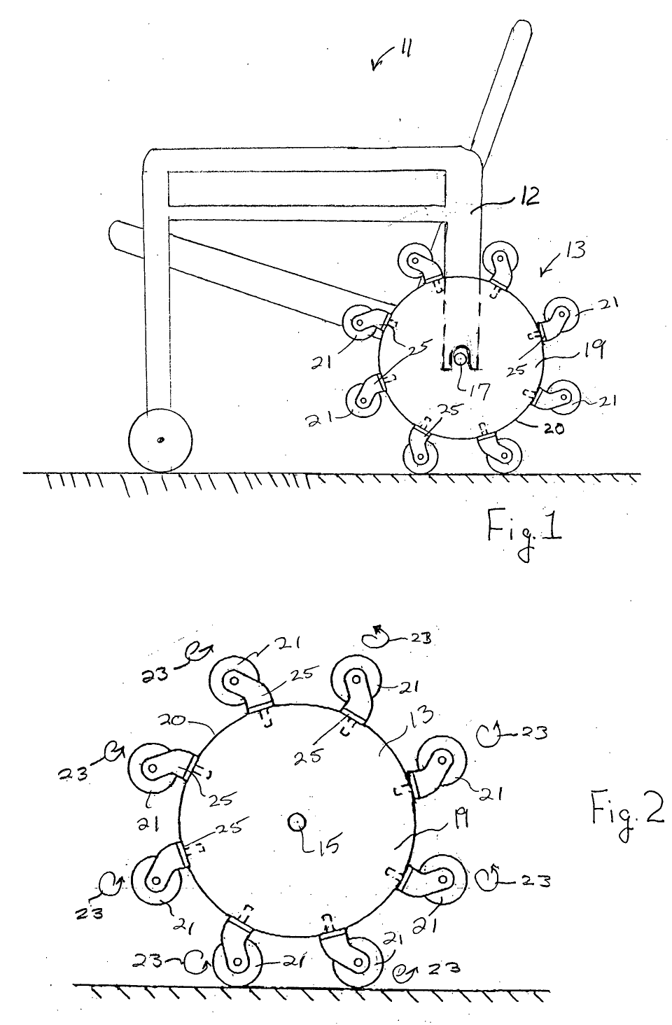

Referencing FIG. 1, a wheeled conveyance, such as the exemplary chair 11, has at the rearward portion of its frame structure 12 a planetary wheel 13. Also referencing FIG. 2, the planetary wheel 13 comprises a central hole 15 for accommodating a primary axle 17 (FIG. 1), a first primary wheel 19 having a first diameter and being concentric with the central hole 15, and a plurality of secondary satellite wheels, collectively 21, mounted at or near the circumference 20 of the primary wheel 19. As illustrated, the primary wheel 19 is solid or without spokes although it will be appreciated that various methods of construction for the primary wheel 19 may be utilized.

The satellite wheels 21 are indicated as being able to swivel and roll when turned about a substantially vertical axis by the rotary arrows 23. As illustrated, the satellite wheels 21 are of smaller diameter than the diameter of the primary wheel 19 and are equally spaced about a circumference 20 of the primary wheel 19. As illustrated in FIG. 1 and FIG. 2, the satellite wheels 21 are caster mounted, with each secondary wheel 21 having its own caster, collectively 25.

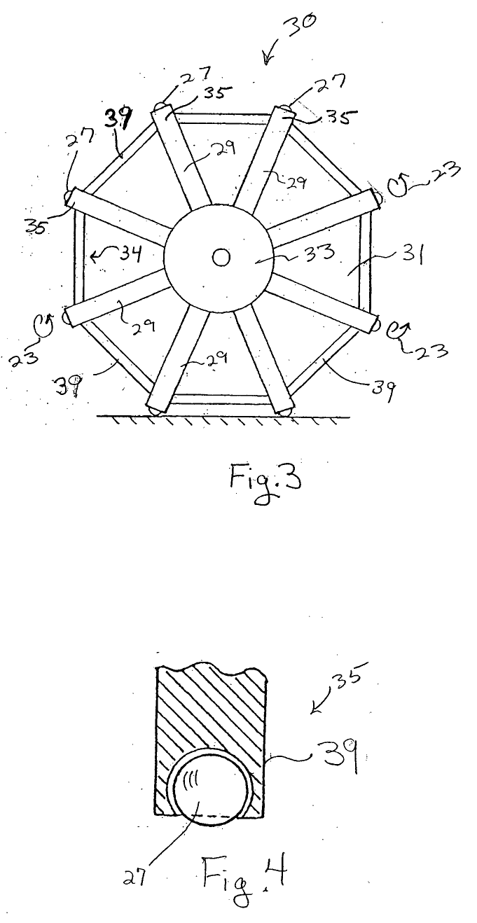

Alternatively as seen in FIG. 3, a planetary wheel 30 may have the satellite wheels, collectively 27, be spherical. Further, according to this embodiment the primary wheel 31 may have spokes, collectively 29, radiating from a central hub assembly 33 to a distal rim assembly 34. The central hub assembly 33 can accept an axle (not shown) and may serve as a means for attachment of the planetary wheel system 30 to a wheeled conveyance such as the rearward leg of the illustrated chair 11 (FIG. 1). Spherical wheel assemblies 35, seen in detail in FIG. 4, have casings 37 containing the spherical satellite wheels 27, are mounted at the distal ends of the spokes 29, so as to allow the satellite wheels 27 to swivel and/or roll in any direction when turned about a substantially vertical axis, as indicated by the rotary arrows 23. The spokes 29 are connected by struts 39 making up the distal rim assembly 34, as located at the distal portions of the spokes 29 for structural integrity. It will be appreciated by the person having ordinary skill in the art that a variety of alternative structural arrangements functionally analogous to the specifically illustrated embodiments may be obtained within the teachings of the present invention.

For example, either of the caster mounted or spherical satellite wheels 21, 27 respectively, may be mounted on or near the circumference of the alternative primary wheel assemblies 19, 31 respectively, or may be used in a substantially similar system to those shown. For another example, the struts 31 of FIG. 3 may be replaced by a solid ring rim assembly to which the spokes 29 may be attached. In any alternative, it will be apparent that the satellite wheels are mounted on the primary wheel so as to swivel and/or roll in any direction when turned about a substantially vertical axis.

While in the foregoing specification this invention has been described in relation to certain preferred embodiments thereof, and many details have been set forth for purpose of illustration, it will be apparent to those skilled in the art that the invention is susceptible to additional embodiments and that certain of the details described herein can be varied considerably without departing from the basic principles of the invention.

1. A planetary wheel comprising
a primary wheel having a first diameter;
a plurality of satellite wheels mounted at or near the circumference of the primary wheel;
the satellite wheels being able to swivel and roll when turned about a substantially vertical axis.

2. The planetary wheel according to claim 1, wherein the satellite wheels are of smaller diameter than the primary wheel diameter.

3. The planetary wheel according to claim 1 wherein the satellite wheels are equally spaced about a circumference of the primary wheel.

4. The planetary wheel according to claim 1 wherein the satellite wheels are caster mounted.

5. The planetary wheel according to claim 1 wherein the satellite wheels are spherical.

6. The planetary wheel according to claim 1 wherein the primary wheel has spokes.

7. The planetary wheel according to claim 6 wherein the satellite wheels are mounted at the distal ends of the spokes.

8. The planetary wheel according to claim 7 wherein the satellite wheels are spherical.

9. A wheeled conveyance, comprising:
a frame structure for accepting an attachment of wheels; and
a planetary wheel attached to the frame structure, the planetary wheel having:
a primary wheel having a first diameter;
a plurality of satellite wheels mounted at or near the circumference of the primary wheel;
the satellite wheels being able to swivel and roll when turned about a substantially vertical axis.

10. The planetary wheel according to claim 9, wherein the satellite wheels are of smaller diameter than the primary wheel diameter.

11. The planetary wheel according to claim 9 wherein the satellite wheels are equally spaced about a circumference of the primary wheel.

12. The planetary wheel according to claim 9 wherein the satellite wheels are caster mounted.

13. The planetary wheel according to claim 9 wherein the satellite wheels are spherical.

14. The planetary wheel according to claim 9 wherein the primary wheel has spokes.

15. The planetary wheel according to claim 14 wherein the satellite wheels are mounted at the distal ends of the spokes.

16. The planetary wheel according to claim 15 wherein the satellite wheels are spherical.
